(19) United States
(12) Patent Application Publication
(10) Pub. No.: US 2020/0338818 A1
(43) Pub. Date: Oct. 29, 2020

(54) METHOD AND APPARATUS FOR ADDITIVE MANUFACTURING

(71) Applicant: Yi-Hsien Harry Teng, Suwanee, GA (US)

(72) Inventor: Yi-Hsien Harry Teng, Suwanee, GA (US)

(21) Appl. No.: 16/757,024

(22) PCT Filed: Oct. 17, 2018
(86) PCT No.: PCT/US2018/056248

§ 371 Date: Apr. 17, 2020

Related U.S. Application Data
(60) Provisional application No. 62/707,022, filed on Oct. 17, 2017.

(51) Int. Cl. B29C 64/165; B29C 64/268; B29C 64/295; B29C 64/321; B29C 64/371; B29C 64/379; B29C 64/236; B29C 64/232; B29C 33/38; G06T 17/00; B29C 64/205

(52) U.S. Cl. CPC B29C 64/165; B29C 64/268; B29C 64/295; B29C 64/321; B29C 64/371; B33Y 10/00; B29C 64/236; B29C 64/232; B29C 33/3842; G06T 17/00; B29C 64/205; B29C 64/379

(57) ABSTRACT

The present invention relates to an additive manufacturing method and apparatus that is configured to construct a mold in additive layers, and a three-dimensional object therein in layers equal to or thicker than the mold construction layers. Without a powder bed needed, the mold defines the geometry, dimensions and surface finish of a three-dimensional object manufactured, so that in the process an energy source or combined sources can be selected from a large group for fusion, sintering, consolidating, joining, curing, or hardening in processing different forms and types of feedstock materials to manufacture metallic, polymeric or composite objects or parts.

### PRIORITY UNDER 35 U.S.C SECTION 119(E) & 37 C.F.R. SECTION 1.78

This nonprovisional application claims priority based on the following prior United States Provisional Patent Application entitled: 3D Additive Manufacturing by Material Fusion, Application No. 62/707,022 filed Oct. 17, 2017, in the name of Yi-Hsien Harry Teng, which is hereby incorporated by reference for all purposes.

### FIELD OF THE INVENTION

The present invention relates generally to a manufacturing method, more specifically but not by way of limitation, a manufacturing method that is configured to manufacture a three-dimensional object within an enclosing structure constructed in additive layers which defines the geometry and dimensions in shaping the three-dimensional object. The enclosing structure is essentially a mold constructed in layers corresponding to a set of cross-section geometries, wherein a feedstock material is provided to manufacture the three-dimensional object.

### BACKGROUND

Numerous types of manufacturing methods and apparatus have been utilized over the last century in a variety of industries. While developed in the past three decades, three-dimensional printing, also known as additive manufacturing has increased in popularity in contrast to conventional subtractive manufacturing techniques such as machining. This new manufacturing approach eliminates traditional tooling and provides a variety of methods for rapid prototyping, and manufacturing using CAD files to fabricate parts from various materials such as but not limited to plastic and metal.

High melting points and complex composition-processing-microstructure-property relationships make metal additive manufacturing a challenging task. Defects or poor quality such as porosity, oxidation, undesired microstructures, unsatisfactory or anisotropic properties, thermal residual stresses, distortion, cracking, dimensional deviation, and surface roughness are common issues that are influenced by process parameters and capabilities. As a result, it is difficult to build confidence in process qualification and control for delivery of consistent, satisfactory quality.

At present, additive manufacturing of metal parts is predominantly carried out by metal powder techniques such as laser powder bed fusion, electron beam powder bed fusion, powder bed printing with binders, and extrusion of powder paste with binders. The powder bed techniques require use of large amounts of metal powder, removal of loose powder from the parts in post processing, and caution in handling and reusing the leftover powder to avoid contamination, oxidation and safety hazards. In some cases, the leftover metal powder cannot be reused, resulting in waste of expensive materials.

Metal powder bed fusion with laser or electron beam is generally very slow because of thin layers typically in the range of 40 to 70 microns, while the cost is quite high due to low productivity and expensive feedstock materials. The metal powder techniques using organic binders produce “green parts” having low volumetric metal contents (approximately 60%), leading to dimensional contraction about 20% in post sintering and causing difficulties in control of shrinkage uniformity, geometry deviation, dimensional accuracy, and process consistency. In addition, any remaining organic binders after “debinding” have to be removed by burnout in the presence of oxygen in the sintering process, which is difficult to control because of an intricate balance between avoiding metal powder oxidation and leaving a carbonaceous residue in the metal parts.

The above-mentioned additive manufacturing techniques are generally suitable for fabrication of a category of small metal parts due to low productivity, high cost, and limited process capability concerns. Accordingly, there is a need for a novel additive manufacturing process that is adapted for the manufacture of larger parts at a higher speed and lower cost, not limited to metal but also suitable for plastic and composite materials.

### SUMMARY OF THE INVENTION

It is the objective of the present invention to provide an additive manufacturing method and system capable of producing a three-dimensional object within a mold such as a shell, not in a powder bed.

Another objective of the present invention is to provide an additive manufacturing method and system capable of producing three-dimensional objects in small to large sizes at increased speeds and reduced costs.

A further objective of the present invention is to provide an additive manufacturing method and system that utilizes a powdered material, a mixture of ingredients, or different forms of feedstock materials for fabrication of metal, plastic and composite parts. The procedures for binder jetting, powder removal and collection from built parts, debinding, binder burnout, and even post sintering are eliminated.

Still another objective of the present invention is to provide an additive manufacturing method and system that is configured to process the feedstock material in the mold with certain types of energy, recipes, and/or conditions for the purpose of fusion, sintering, coalescence, joining, reacting, or hardening in formation of a three-dimensional object with a desirable microstructure, composition, and properties.

To the accomplishment of the above and related objectives the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following detailed description and appended claims when taken in conjunction with the accompanying drawings wherein:

FIG. 1 is an exemplary process flowchart of the manufacturing method of the present invention; and

FIG. 2a through FIG. 2d provide schematic views of the apparatus of the present invention in certain embodiments.

### DETAILED DESCRIPTION

The present invention relates generally to an additive manufacturing method and system configured to manufacture a three dimensional object by constructing a mold in additive layers corresponding to a set of cross-section geometries, wherein a feedstock material is provided and processed in the formation process of the three dimensional object. The mold, or a portion of the mold as it is being constructed is an enclosing structure that forms a cavity for shaping a three-dimensional object having exterior and interior surfaces, so that a feedstock material is provided and processed therein after at least one layer of the mold is constructed. The construction of the mold and the object continues till the end of the operation when the three-dimensional object is complete.

Preferably, the mold is constructed in a shell structure with thin walls to reduce material and time consumptions in the manufacturing process, such that the terminologies “shell” and “mold” may be used interchangeably in the context of present invention unless a specific reference is described.

Since the mold or shell defines the shape and dimensions of a three-dimensional object to be manufactured, finely focused energy beams such as laser and electron beam are not mandatory for use in additive manufacturing of metal parts in the present invention. Without a powder bed surrounding the shell and the feedstock material therein, alternate types of energy sources can be used for simultaneous, “macroscopic” processing of the feedstock material in an enlarged area and increased layer thickness without affecting the dimensional resolution and surface finish. In other words, the dimensional accuracy and surface finish of an object manufactured in a shell depend primarily on the capability of shell construction process, allowing fusion, sintering, curing or hardening in a large volume of feedstock material. Accordingly, its productivity and capability advantages will be evident in additive manufacturing of larger metal parts and certain difficult-to-make parts such as composites.

After the three-dimensional object is completely constructed, the shell can be removed in post processing. In some cases, the shell constructed is joined with the feedstock material therein, forming a surface portion of the three-dimensional object. This approach offers options for hybrid material constructions in the three-dimensional objects for certain applications with benefits of special properties and reduced costs.

Referring to the drawings submitted herewith, wherein various elements depicted therein are not necessarily drawn to scale or completion, wherein through the views and figures like elements are referenced with identical reference numerals, there is illustrated an additive manufacturing method along with an exemplary system constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

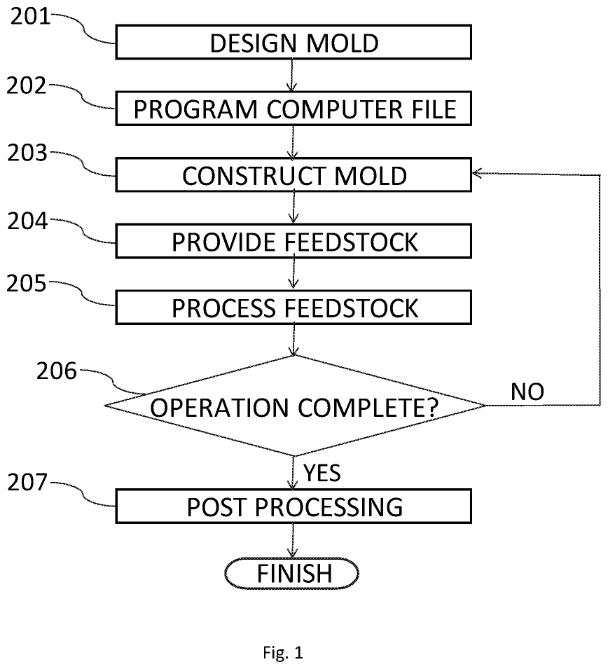

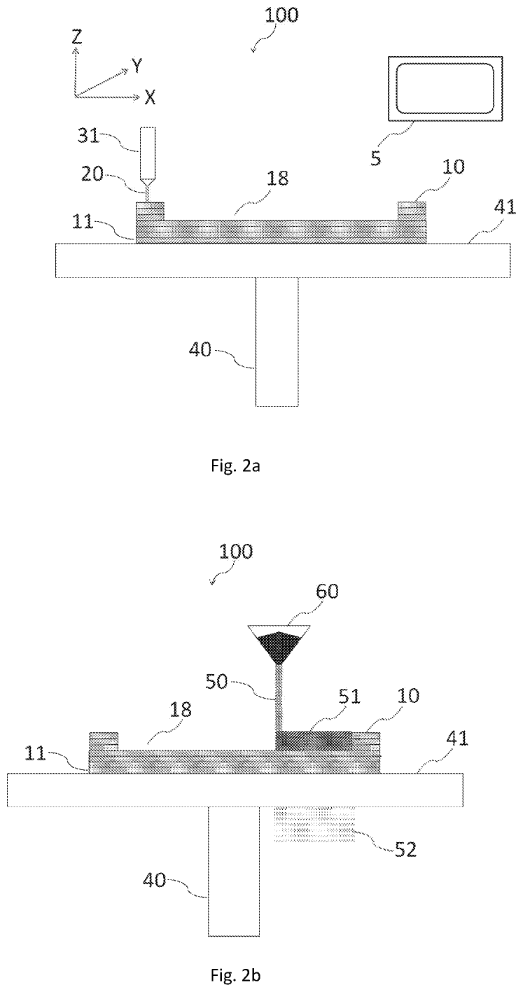

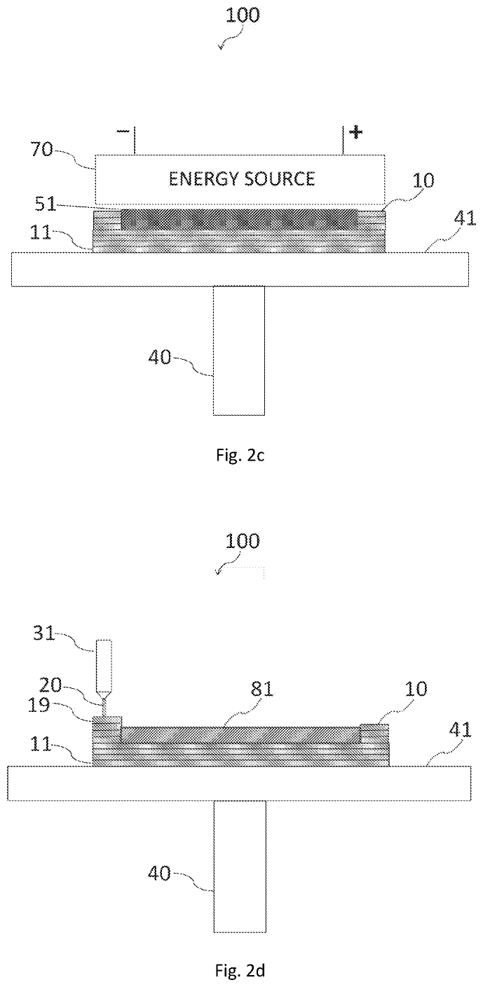

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic. Referring to FIG. 1, a flow chart of an exemplary process is illustrated therein, which can be further demonstrated by an additive manufacturing system 100 shown in FIG. 2a through FIG. 2d that is again exemplary for the present invention. In step 201, a user will utilize a CAD software to design a mold 10 corresponding to a design of the three-dimensional object to be manufactured, and create a CAD model describing the mold geometry and dimensions in a selected format. It is preferred to design the mold 10 in a shell-like structure with thin walls to minimize the consumption of mold making material 20 as well as the rum time in the mold constructing process. The design of mold 10 and selection of mold making material 20 should take account of the processing conditions and ensure that the mold 10 can withstand the processing of selected feedstock material 51 and manufacturing of the three-dimensional object.

A cavity in the mold or shell 10 performs a shaping function in formation of at least a portion of a three-dimensional object therein, so that the mold cavity 18 is also called a shaping cavity in the present invention.

Step 202 involves creating a computer file with a software program through slicing the CAD model for the mold design into a set of cross-section geometries and incorporating the data, process settings and control specifications for construction of the mold 10 and the three-dimensional object therein in the additive manufacturing system 100.

Depending on the mold construction process, a ceramic powder, metal powder, mineral powder, or another inorganic powder along with an inorganic or polymer binder are typically used in formulating a mold making material 20 as a paste or slurry for extrusion or material jetting. FIG. 2a shows an extruder 31 as used in some embodiments in providing a mold making material 20 to construct the mold 10. A slurry having an adequate solid content and viscosity can be extruded as well in different embodiments. A low-viscosity slurry may be jetted through a nozzle under appropriate hydrostatic pressures. The methods of extrusion and material jetting may also be used with a polymer melt or resin to construct the mold 10 for certain applications.

To use directed energy deposition processes including laser, electron beam and electric arc melting in certain embodiments, metallic materials in a form of powder, wire or filament can be used to construct a metal mold 10 such as a shell. With a suitable alloy used in at least a portion of the shell, the shell material can be joined with a metal feedstock material 51 in the shell cavity 18 to form a hybrid metal part. For example, when superior surface properties are required as in the case of metal parts for wear- or corrosion-resistant applications, a high performance but expensive alloy can be used to build the shell which can offer desirable properties in at least a portion of the surface areas of the metal parts, while a different feedstock alloy that offers a low cost or compensating properties can fill into the shell cavity in a hybrid alloy construction. These embodiments are particularly useful in manufacturing medium to large parts for cost reduction and performance enhancement.

For certain applications, a metal foil, fabric, paper, or polymer film can be used to construct a mold 10 in a sheet lamination process.

In step 203, a program runs the computer file in a computer or controller 5 that is integrated into the system or has connection to the system to start the construction of the mold 10 with the first layer 11 built on a solid substrate such as a build plate 41. Attached to the Z axis assembly 40, the build plate 41 can be metal or ceramic for additive manufacturing of a metal part or at high temperatures. In some embodiments, the mold 10 separate the build plate 41 and the object bottom layer 81. In other embodiments, especially when electric arc heating or electron beam heating is employed in processing the feedstock material 51 for metal parts, the metal objects are required for conduction of electricity to the build plate 41, so that at least a portion of a metal part 81 should be built on a metal build plate unless the connection is made possible otherwise.

In some embodiments, heating or curing is required to harden the mold 10 being constructed before use. Applying certain types of energy or adjusting the process conditions can be effective to harden the mold 10. In manufacturing metal parts at high temperatures in the present invention, the heat from the hot parts being constructed can be adequate for the mold hardening requirement.

When construction of the mold 10 reaches a pre-specified layer number or numbers, the process will pause, and step 204 starts. A selected feedstock material 50 will be metered into the mold cavity 18 from a feedstock dispenser 60 which can move in the X and Y directions under control of the computer 5 in tracking the mold cavity 18 in its path of movement and providing a correct amount of feedstock material. Any redundant feedstock material 50 falling out of the mold cavity 18, will be collected. An embodiment shown in FIG. 2b illustrates a build plate 41 that allows the redundant feedstock material 50 to fall through holes or openings in the build plate 41 and be collected underneath. With help of vibration of the build plate 41 and vacuum collection in some embodiments, collection of the feedstock material 50 can be more efficient. In addition to vacuum collection, alternate methods can be used such as magnetic collection, and sweeping if applicable.

It is necessary to increase the density of feedstock material 51 in the mold cavity 18 by compaction before the feedstock material 51 is processed. Some embodiments utilize mechanical compaction methods including but not limited to vibration, shaking, roller compaction, and pressing.

The feedstock materials are selected from the categories of metallic, plastic, ceramic, inorganic, and composite materials. The feedstock material may consist of a single component or multiple components or ingredients, comprising a powdered material, filament material, fibrous material, sheet-like material, liquid ingredient, or a combination thereof with examples including but not limited to powders, binders, additives, short fibers, long fibers, fiber strands, woven and weaved fabrics, nonwoven fabrics and mats, preforms, and scrims.

In step 205, processing of feedstock material 51 in the mold cavity 18 starts using an energy source or combined energy sources in various embodiments for fusion, sintering, hardening, joining, consolidation or curing in shaping at least a portion of the three-dimensional object, In various embodiments, the energy sources are selected from a list comprising but not limited to electromagnetic induction heating, electric arc heating, electric resistance heating, laser heating, electron beam heating, plasma heating, fuel combustion heating, torch heating, ultraviolet lighting, infrared radiant heating, microwave radiant heating, radio frequency radiant heating, pressing, gas pressurizing, ultrasonic vibration for solid state joining, The goal in the processing is for the objects or parts manufactured to meet the design specifications, and achieve a desirable microstructure evaluated by the grain size, morphology, constituents, phases, porosity, layer adhesion, inclusions and other features, and required properties measured by strength, hardness, ductility, toughness, density, etc.

For additive manufacturing of metal parts at high temperatures, a certain protective gas atmosphere is often required to minimize the oxygen level in the surrounding and avoid oxidation of metal powder. Some embodiments utilize argon, nitrogen, or carbon dioxide, while some other embodiments utilize vacuum or a reducing atmosphere containing hydrogen.

In addition to application of energy in processing of feedstock material 51, some embodiments also utilize chemical reactions and physical state changes such as exothermic reactions, self-propagating processes, cross-linking, chemical bonding, or solidification for curing, hardening, consolidating, joining, sintering, or fusing the feedstock material 51.

After processing of the feedstock material 51 in the mold cavity 18, at least a layer of the three-dimensional object or part is complete. Before the complete object or part is constructed, steps 203, 204 and 205 will be repeated in continuation of the process. After completion of the process, the object or part constructed will undergo post processing to remove the mold or shell and perform necessary procedures such as but not limited to cutting, grinding, sand blasting, heat treating, machining in order to meet the specifications and quality requirements.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method for additive manufacturing of a mold and a three-dimensional object therein, comprising the steps:
(a) designing a CAD model for a mold corresponding to a design of a three-dimensional object;
(b) generating a computer file, said computer file being configured for executing the task of additive manufacturing operation;
(c) providing an apparatus, said apparatus being configured to run the computer file and perform the operation;
(d) constructing at least a portion of a mold in one or a plurality of layers to form a shaping cavity;
(e) providing a feedstock material in the shaping cavity; and
(f) processing the feedstock material in the shaping cavity to form at least a portion of the three dimensional object;
wherein the steps (d) to (f) are repeated in continuation of the process until the construction of the mold and three-dimensional object is complete.

2. The method of claim 1, wherein the computer file is configured with a set of cross-section geometries sliced from a CAD model for the mold design.

3. The method of claim 1, wherein the mold is a shell with thin walls.

4. The method of claim 3, wherein the shell is joined with and integrated into the three-dimensional object.

5. The method of claim 1, wherein the mold is constructed by a process of material extrusion, directed energy deposition, material jetting, binder jetting, sheet lamination, machining, or a combination thereof.

6. The method of claim 1, wherein the feedstock material consists of a single component, multiple components or ingredients, said feedstock material being selected from the categories of metallic, polymeric, organic, inorganic and composite materials.

7. The method of claim 1, wherein the feedstock material comprises a powdered material, filament material, fibrous material, sheet-like material, impregnated strand, impregnated fabric, liquid ingredient, or a combination thereof.

8. The method of claim 1, further comprising a process for the feedstock compaction in the shaping cavity.

9. The method of claim 1, wherein the feedstock material is processed in the shaping cavity with an energy source or combined energy sources selected from a group of laser heating, electron beam heating, plasma heating, electric arc heating, electric resistance heating, fuel combustion heating, torch heating, electromagnetic induction heating, pressing, gas pressurizing, ultraviolet lighting, infrared radiant heating, microwave radiant heating, radio frequency radiant heating, and ultrasonic welding.

10. The method of claim 1, wherein the feedstock material is processed in the shaping cavity to undergo a process of fusion, sintering, consolidating, joining, curing, reacting, or a combination thereof in forming the three-dimensional object.

11. The method of claim 1, wherein the feedstock in the shaping cavity is processed by providing a gaseous or aerosol reactant.

12. An additive manufacturing system configured to construct a mold and a three-dimensional object therein, comprising:
(a) a computer, said computer being integrated, a standalone or network-based with connection to said system;
(b) an apparatus, said apparatus being configured to construct a mold in a plurality of layers corresponding to a set of cross-section geometries;
(c) a feeding device, said feeding device being configured to provide a feedstock material or multiple components in a cavity in at least a portion of the mold already constructed; and
(d) a processing device or processing facility being configured to process the feedstock material in the cavity in formation of the three-dimensional object.

13. The additive manufacturing system of claim 12, wherein the apparatus is configured to construct a mold layer by layer in a process of material extrusion, directed energy deposition, material jetting, binder printing, sheet lamination, machining, or combination thereof.

14. The additive manufacturing system of claim 12, wherein the apparatus is configured with an energy source to harden, dry or cure the mold in the mold construction process.

15. The additive manufacturing system of claim 12, wherein the system is configured to process the feedstock material in the mold cavity with an energy source in a process of fusion, sintering, consolidating, joining, reacting, curing, or hardening.

16. The additive manufacturing system of claim 15, wherein the energy source is selected from the list comprising: electromagnetic induction heating, electric arc heating, electric resistance heating, laser heating, electron beam heating, plasma heating, fuel combustion heating, torch heating, ultraviolet lighting, infrared radiant heating, microwave radiant heating, radio frequency radiant heating, pressing, gas pressurizing, ultrasonic joining.

17. The additive manufacturing system of claim 12, where the system is configured to process the feedstock material in an environmental atmosphere that has a substantially reduced level of oxygen therein.

18. The additive manufacturing system of claim 12, wherein the system is configured to process the feedstock material in an inert gas atmosphere.

19. The additive manufacturing system of claim 12, further comprising a robotic arm for constructing a mold, providing a feedstock material, processing the feedstock material, or manufacturing a three-dimensional object.

20. The additive manufacturing system of claim 12, wherein the system has a frame assembly, robotic arms, or a combination thereof, so as to facilitate X, Y and Z axis movement.
